(19) United States
(12) Patent Application Publication
(10) Pub. No.: US 2011/0066401 A1
(43) Pub. Date: Mar. 17, 2011

(54) SYSTEM FOR AND METHOD OF MONITORING AND DIAGNOSING THE PERFORMANCE OF PHOTOVOLTAIC OR OTHER RENEWABLE POWER PLANTS

(75) Inventors: Stephen C. Yang, Los Altos, CA (US); Robert M. Getsla, San Jose, CA (US)

(73) Assignee: WATTMINDER, INC., Sunnyvale, CA (US)

(21) Appl. No.: 12/878,664

(22) Filed: Sep. 9, 2010

Related U.S. Application Data
(60) Provisional application No. 61/241,523, filed on Sep. 11, 2009.

(51) Int. Cl. G06F 15/00; G01J 1/42

(52) U.S. Cl. 702/184; 702/183; 702/185; 356/222

(57) ABSTRACT

Energy converters are monitored to ensure that they are operating at acceptable levels. An expected output is predicted using mathematical modeling and compared to the actual output generated by the energy converter. When the difference is above a predetermined threshold, the level of underperformance, along with other parameters, are used to determine a possible cause of underperformance and actions that can be taken to increase the output to acceptable levels. The cause and actions are transmitted to personnel, who are dispatched to service the underperforming energy converter. By centrally locating the mathematical modeling, monitoring, and dispatching, multiple PV modules can be managed from a remote location. When monitoring photovoltaic modules, an irradiation sensor employs multiple photosensors oriented to detect not only the normal components of sunlight but also directional, diffused components of sunlight, thereby increasing the accuracy of the mathematical modeling.

### RELATED APPLICATION

This application claims priority under 35 U.S.C. §119(e) from the co-pending U.S. provisional patent application Ser. No. 61/241,523, filed Sep. 11, 2009, and titled “Diagnostic System for a Photovoltaic (Renewable) Power Plant,” which is hereby incorporated by reference.

### FIELD OF THE INVENTION

This invention is related to energy converters. More particularly, this invention is related to monitoring the performance and diagnosing any underperformance of energy converters, such as photovoltaic arrays.

### BACKGROUND OF THE INVENTION

Because they rely on a freely available and renewable energy sources, are environmentally friendly, and pay for themselves by reducing energy costs, photovoltaic (PV) modules are used on an increasing number of homes and businesses. When PV modules are combined in a PV power plant, they can power entire communities. When these PV modules in a PV power plant are not operating at optimum efficiency, however, their underperformance is felt on a larger scale: Entire communities can be affected by lower power production. By some estimates, underperforming modules in PV power plants reduce productivity and resulting profits of the PV power plant operators by up to 20%.

Some PV power plants are monitored using “Symmetry Analysis,” a method that compares the currents through different strings of a PV module. When any two currents differ by a predetermined amount, the monitoring system determines that the string with the smaller current is underperforming and generates an alarm message. Other monitoring systems use a “day-before” comparison, in which the day's current through each string is compared to the previous day's current through the same string. Large enough differences again indicate a malfunctioning string.

Whatever abnormality-discovering method is used, staff are required to monitor the performance of the PV modules around the clock. This type of monitoring is only as effective as the staff are diligent and the measuring equipment is accurate. Even then, most staff members are not trained to determine whether any underperformance is truly indicative of a malfunctioning PV module and, if so, the cause. Even fewer staff are qualified to determine how to remedy the underperformance. By the time a problem is found and a remedy is applied, the accumulated lost productivity can be significant.

### BRIEF SUMMARY OF THE INVENTION

In accordance with embodiments of the invention, a system monitors one or more energy converters, such as a photovoltaic array or wind turbine, to ensure that they are operating at acceptable levels. The system compares the actual output of the energy converter to a predicted output, generated using a mathematical model of the energy conversion unit. When the system determines that the energy converter is underperforming, it determines possible reasons for the underperformance, schemes to diagnose the underperformance, and remedial actions for increasing the performance to acceptable levels. All of this information can be displayed to personnel monitoring the output generated by energy converters. This information, or a subset of it, is then assembled into messages transmitted to personnel to service the energy converters.

In one aspect, a system for monitoring an efficiency or health status of an energy converter includes a module that determines an amount an output of the energy converter differs from a predicted output (an underperformance value), a possible cause of underperformance, a strategy for diagnosing the possible cause of the underperformance, a corresponding remedial action, or any combination thereof. The predicted output is based on operating conditions of the energy converter, such as a current time of day, a current month, or both. Alternatively, the operating conditions correspond to a microclimate surrounding the energy converter.

The system also includes a monitor for measuring the output of the energy converter and a transmission module for notifying an agent (e.g., a staff member or dedicated service personnel) when an underperformance metric of the energy converter exceeds a predetermined threshold.

The predicted output, the possible cause of the underperformance, a strategy for diagnosing the possible cause of underperformance, the corresponding remedial action, or any combination thereof are automatically determined using a learning algorithm.

In a second aspect, a system for monitoring an efficiency of a photovoltaic array includes a monitor that measures an output of the photovoltaic array and a first module that determines an amount the output differs from a predicted output of the photovoltaic array. The first module also determines a possible cause of underperformance for the photovoltaic array, a strategy for diagnosing the possible cause of underperformance, a corresponding remedial action, or any combination thereof.

Possible causes of underperformance include theft or vandalism of a component of the photovoltaic array, a fault in the photovoltaic array, a presence of an object blocking illumination to the photovoltaic array, or any combination thereof.

In one embodiment, the predicted output is determined from an amount of irradiation striking the photovoltaic array, an incidence angle of irradiation striking the photovoltaic array, a temperature of the photovoltaic array, or any combination thereof. Alternatively, or additionally, the predicated output is based on predetermined operating characteristics of the photovoltaic array.

In a third aspect, a system includes a first module that determines underperformance values of multiple energy conversion units in multiple different geographic locations and a second module that determines for each of the underperformance values a possible cause of underperformance, a strategy for diagnosing a cause of the underperformance, and a corresponding remedial action. The first module monitors outputs from each of the multiple energy conversion units to determine the underperformance values. The second module monitors current microclimates surrounding each of the multiple energy conversion units to determine the underperformance values.

In a fourth aspect, a device includes multiple light detectors aimed in different directions. The device is configured to determine irradiance impinging on the multiple light detectors. A portion of the multiple light detectors are directed outwardly at different angles about a central axis. The different directions include a first direction along a first vector and second directions at one or more angles to the first vector.

In one embodiment, the multiple light detectors include a pyranometer directed in the first direction and multiple photosensors directed in the second directions. Preferably, the device also includes an opaque shield between the pyranometer and the multiple photosensors. The shield is arranged, in size and location, to shadow the multiple light detectors from sunlight traversing an arc through a normal to the pyranometer.

### BRIEF DESCRIPTION OF THE SEVERAL VIEWS OF THE DRAWINGS

FIG. 1 illustrates monitoring the efficiency of a PV module mounted to a roof of a house in accordance with embodiments of the invention.

FIGS. 2A and 2B are displays of underperformance information and suggested remedial actions, in accordance with embodiments of the invention.

FIG. 3 shows the components of the PV module of FIG. 1 in more detail.

FIG. 4 is a high-level diagram of components for remotely monitoring the performance of and dispatching service personnel to a PV module in accordance with embodiments of the invention.

FIG. 5 is a block diagram of components of a module for measuring performance of a PV module in accordance with embodiments of the invention.

FIG. 6 shows components of a data warehouse in accordance with embodiments of the invention.

FIG. 7 shows the functional relationship between a fault diagnostics inference engine and a data warehouse in accordance with embodiments of the invention.

FIG. 8 shows a table storing performance data in accordance with embodiments of the invention.

FIGS. 9A-C show tables storing information used to predict performance data for a PV module in accordance with embodiments of the invention.

FIG. 10 is an insolation map used to predict performance of PV modules in accordance with embodiments of the invention.

FIG. 11 shows an a posteriori probability matrix in accordance with embodiments of the invention.

FIG. 12 shows a fault dictionary in accordance with embodiments of the invention.

FIGS. 13A and 13B are perspective and top views, respectively, of a light detection module in accordance with one embodiment of the invention.

FIGS. 14A and 14B are perspective and top views, respectively, of a light detection module in accordance with one embodiment of the invention.

FIG. 15 shows a table containing parameters for predicting an instantaneous power output from a PV module in accordance with embodiments of the invention.

FIG. 16 shows graphs of estimated current versus estimated voltage and estimated power versus estimated voltage, both used in accordance with embodiments of the invention.

FIG. 17 is a Web page displaying information about a PV site, sun, and PV module operating performance in accordance with embodiments of the invention.

FIG. 18 is a flow chart of steps to monitor and service underperforming PV modules in accordance with embodiments of the invention.

FIG. 19 depicts multiple locations containing PV modules and components for monitoring and servicing them in accordance with embodiments of the invention.

FIGS. 20A-C show alternative energy converters monitored in accordance with embodiments of the invention.

### DETAILED DESCRIPTION OF THE INVENTION

In accordance with embodiments of the invention, energy converters, such as photovoltaic (PV) cells, wind turbines, and water turbines, are monitored in real time to ensure that they are performing at acceptable, pre-determined levels. Performance metrics, such as power generated for the day, are displayed on a Web or other page. When an energy converter underperforms, the amount of underperformance is automatically calculated and used to determine the cause of underperformance and possible remedial actions. The remedial actions are included in instructions to service personnel, who can then service the energy converter. By taking steps to quickly return the energy converter to acceptable levels of operation, the overall output of the energy converter is maximized, critical in large-scale energy conversion systems such as PV power plants. In this way, the overall health status of an energy converter (or multiple energy converters) can be monitored and maintained.

Underperformance can be determined in any number of ways. As one example, underperformance is measured as the difference between a predicted power output of the energy converter and its actual power output. When the energy converter is a PV module composed of multiple PV arrays (solar panels), the output is predicted by generating a mathematical model that characterizes an optimal output based on parameters such as solar radiation, temperature, time of day, orientation of the PV module to the sun, and PV module ratings, to name only a few such parameters. The actual output, whether measured in power, current, or voltage, is compared to this benchmark to determine an underperformance metric. The model can be refined over time to increase its accuracy.

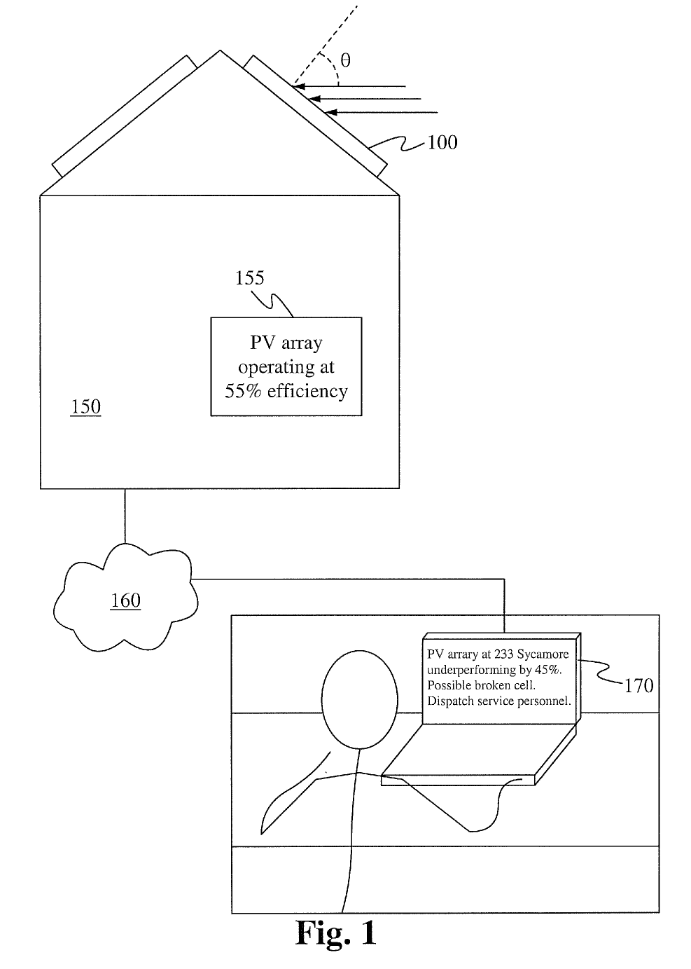

FIG. 1 shows an energy conversion unit 100, a photovoltaic (PV) array mounted atop a building 150. The PV array 100 contains, among other things, an array of PV cells or panels and associated circuitry. Two displays, one display 155 inside the building 150 and another display 170 coupled to the PV module 100 over the Internet 160, display the operating efficiency of the PV module 100. The display 170 also indicates a possible cause of the underperformance, a broken cell of the PV module 100. A technician viewing the message on the display 170 can be dispatched to repair the PV array 100.

It will be appreciated that the displays 155 and 170 can be on any type of device. As only some examples, the display 155 is on a personal computer, a smart phone, or a personal digital assistant, and the display 170 is on a smart phone or a pager capable of displaying short message service (SMS) messages.

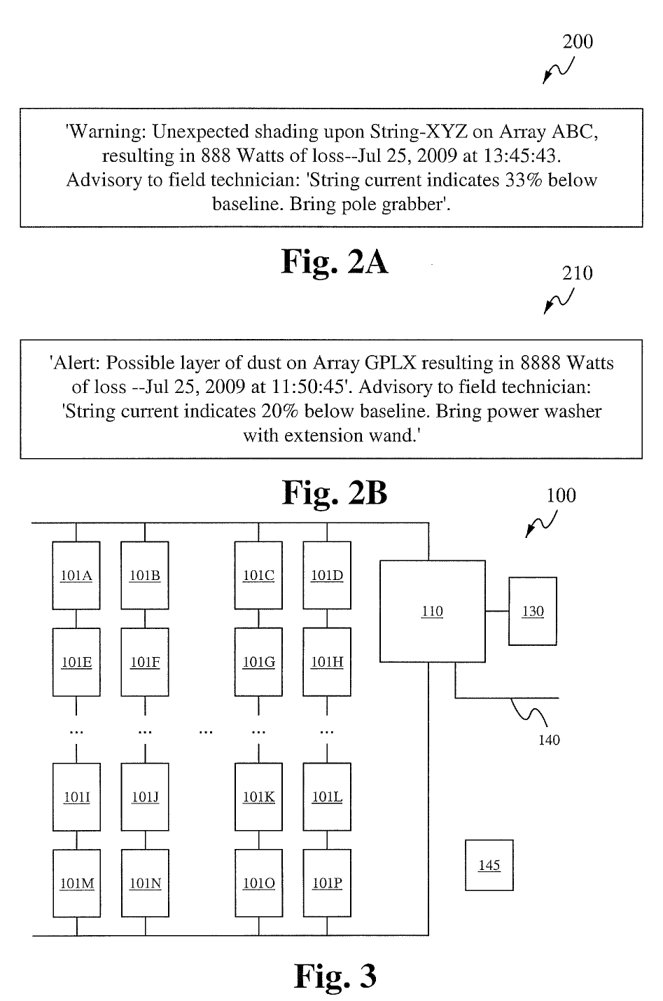

Many conditions can cause the PV module 100 to underperform, with corresponding different remedial actions. FIGS. 2A and 2B, for example, show two messages 200 and 210 generated on different occasions when the PV module 100 underperforms by different amounts. As explained below, the messages 200 and 210 can be displayed on the display 155, the display 170, or on other displays at other locations. The “warning” message 200 in FIG. 2A was generated seconds after a leaf dropped onto a surface of the PV module 100, covering much of one of its solar panels. The message 200 was generated based on the following parameters: One minute before the message 200 was generated, the measured output was 2,300 W, the predicted (benchmark) output was 2,650 W, and the irradiance was 3% higher than the present value. The message 200 states that an unexpected shading across the PV module 100 caused a loss of power. The message 200 includes a remedial action for remedying the loss: using a pole grabber to remove an obstacle from a surface of the PV module 100.

The “alert” message 210 in FIG. 2B was generated after dust had been gathering on a surface of the PV module 100 over the last 3 months. The message 210 states that a possible layer of dust on the PV module 100 caused a loss of power. The message 210 also includes a remedial action: using a power washer to spray away the layer of dust. The message 210 was generated based on the following parameters: A maintenance log indicated that it had been 3 months since the last power wash, and no rain was recorded since then. The output is 3.4% below the benchmark output. A message is entered into a batch advisory to schedule a power wash for the PV module 100.

The possible causes of underperformance and corresponding remedial actions can be determined from a number of factors, including the amount of underperformance, the rate of change of underperformance, current weather conditions, and the current season, to name only a few factors. For example, quick but large changes in performance during calm summer months can indicate a component failure, requiring the replacement of the component. Small but quick changes during windy months can indicate the falling of a branch or leaves onto a surface of the array of PV cells, requiring service personnel to bring a pole grabber. Small but gradual changes during dry months can indicate the accumulation of dust or soot on a panel of a PV module, requiring service personnel to bring a spray washer. Small but gradual changes during cloudy moments followed by a return to normal performance levels can indicate the movement of overhanging clouds, requiring no action by service personnel.

FIG. 3 shows some of the components of the PV module 100, used to explain the subject of performance messages generated in accordance with embodiments of the invention. As in all the figures, identical labels refer to identical or similar elements. The PV module 100 includes separate PV cells or panels 101A-P (collectively, 101) coupled to a module 110. The module 110 includes combiner box instrumentation, a data acquisition controller (discussed below), and an Internet Gateway micro Web server. The module 110 is coupled over the line 140 to a local area network, which is coupled to the Internet 160 (FIG. 1) to transmit performance metrics of (e.g., actual power generated by) the PV module 100. The module 110 is also coupled to a load/grid (not shown) through an inverter 130. The inverter 130 transforms DC power generated by the array of PV modules 101 into AC power available at the power sockets of the building 150. The PV module 100 also includes an irradiance sensor 145 mounted adjacent to the PV cells 101.

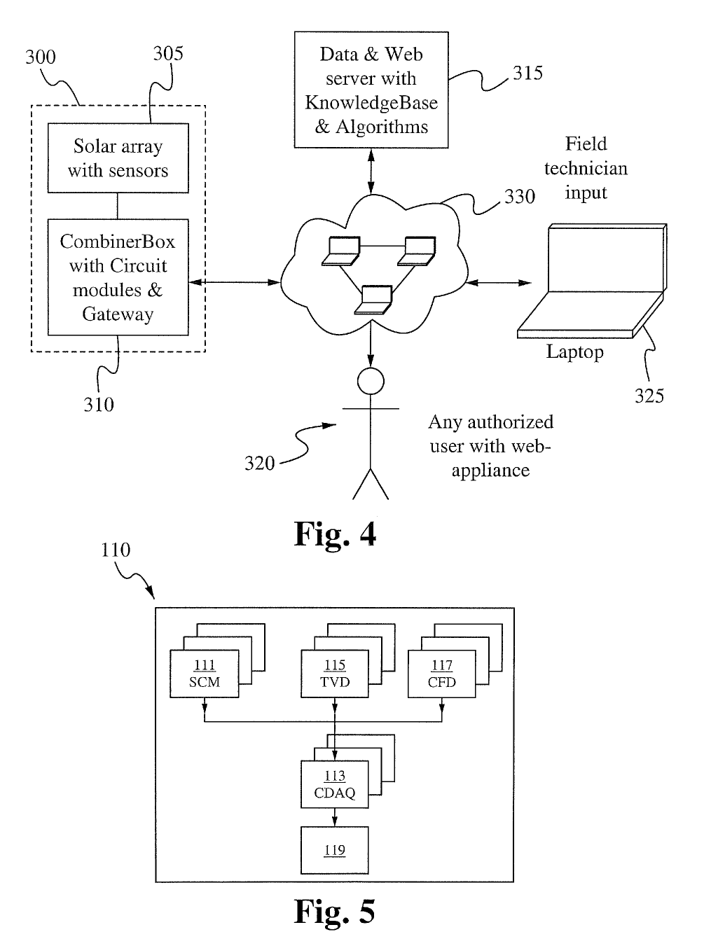

FIG. 4 is a high-level diagram illustrating how the performance of a PV module 300 is monitored in accordance with embodiments of the invention. As shown in FIG. 4, the PV module 300 contains a solar array with sensors 305 coupled to a combiner box with circuit modules and a Gateway 310. The PV module 300 receives solar energy and translates it into any combination of AC current, voltage, and power (collectively referred to as AC power). The Gateway transmits information indicating the generated AC power over the Internet 330 to a Data and Web Server 315, which includes a Knowledge Base and Algorithms, described in more detail below. The Data and Web Server 315 uses the information to determine whether the PV module 300 is underperforming and, if so, the amount of underperformance, reasons for the underperformance, and any remedial actions that can be taken to increase performance, collectively referred to as the “performance and service data.” The Data and Web Server 315 then transmits text or other data used by a system 325 to display the performance and service data, such as to service personnel.

FIG. 5 shows some of the components of the module 110 in accordance with one embodiment of the invention. The module 110 includes one or more (as shown by the overlapping rectangles) Signal Conditioning Multiplexers (SCM) 111, one or more Custom Data Acquisition Modules (CDAQ) 113, one or more Theft-Vandal Detectors (TVD) 115, one or more Component Fault Detectors (CFD) 117, and an Internet Gateway module 119. (To simplify the following discussion, one or more of an element in FIG. 5 will be referred to in the singular.) The SCM 111 accommodates a number of different sensor signals such as various brand and models of irradiance, temperature, voltage and current sensing transducers. The SCM 111 achieves “Galvanic” isolation, such that the circuitry inside the SCM 111 and its interconnected members are protected from the hazardously high DC output of the modules and the strings of the PV module 100. The SCM 111 can be configured in the field for the specific needs of the PV module 100 being monitored, selecting the parameters transmitted to a database server (e.g., Data & Web server 315 in FIG. 4), discussed below.

The CDAQ 113 receives sensor signals from the SCM 111 and transforms the signals into computer-understandable words that are manipulated, compared, analyzed, and stored in database tables for future retrieval, processing, and display. The CDAQ 113 also transmits performance and other information, such as over the Internet, through the Internet Gateway module 119, for display on a Web page.

Normally, the CDAQ 113 samples performance metrics at a rate of about 3 samples per second. In a hardware diagnostic mode, during which the CDAQ 113 performs burst sampling at a rate of up to 100,000 samples per second, the CDAQ 113 is also referred to as a high-speed digital signal processor because it brings signals from points at the interface between the PV cells and the inverter 130 (FIG. 3). In the hardware diagnostic mode, the CDAQ 113 functions like an oscilloscope and is thus referred to as a “virtual scope signal processor.” The CDAQ 113 is used to generate what is alternatively called an “XY-display,” a “virtual oscilloscope displaying electrical waveforms,” or parameters with a time or frequency scale reference.

The TVD 115 is used to detect the theft or vandalism of components of the PV module 100. The TVD 115 functions by monitoring “always-on” electrical signals, generated when the components of the PV module 100 are in place and working properly. When any component of the PV module 100 is disconnected or vandalized, a corresponding “always-on” electrical signal is turned off. This condition is transmitted to a database server and supervisory program for validation. An alert message is then generated and transmitted to designated personnel.

The CFD 117 monitors the PV module 100 for specific malfunctioning components, such as a leaky capacitor, shorted or open diodes, or other physical damage to the PV module 100 or inverter 130. This condition is transmitted to the database server and the supervisory program for validation, and an appropriate alert message is transmitted to the designated personnel.

The module 110 includes computer-readable media containing the algorithms for performing the steps executed by the SCM 111, the CDAQ 113, the TVD 115, the CFD 117, and the Internet Gateway module 119. The module 110 also includes one or more processors configured to execute those steps. The number of instances of each of the modules 111, 113, 115, and 117 depends on the size of the entire energy converter. Each of the modules 111 and 113 is capable of accommodating up to 8 sensor signals, while each of the modules 115 and 17 works with one string of solar panels.

In accordance with embodiments of the invention, a data warehouse stores, among other things, performance and service data used to track underperformance and to determine remedial actions. In one embodiment, a data warehouse is remote from the module 110 (FIG. 4). Those skilled in the art will recognize other locations on which a data warehouse can be housed.

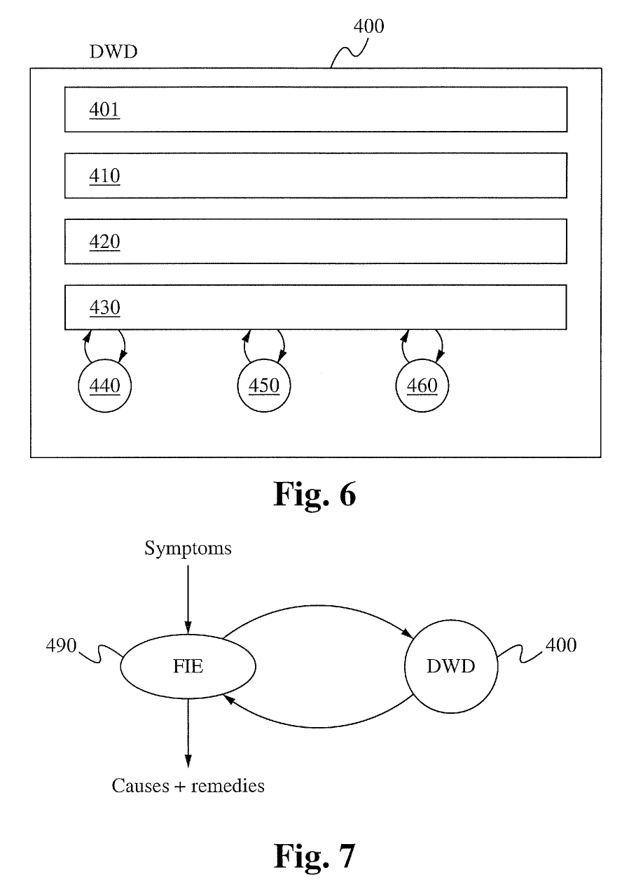

FIG. 6 shows a data warehouse (DWD) 400 in accordance with embodiments of the invention. In one embodiment, the DWD 400 forms part of the Data and Web server 315 of FIG. 4. The DWD 400 stores records corresponding to performance and other data transmitted from the SCM 111, the CDAQ 113, and Gateway module 119 of FIG. 5. The data include the archived performance data for a PV module. The data are processed and transformed into a form that is suitable for storage on and retrieval from the Data and Web server 315 and that allows for easy access and processing by classification and diagnostic algorithms. Preferably, the Gateway module 119 has a non-volatile memory configured to store performance data for several days, in case an Internet or other connection is broken, preventing data from being transferred for remote storage and display.

Referring to FIGS. 4 and 6, the DWD 400 contains a performance record database (PRD) 401 that stores records of performance data for the PV module 300, a Fault Dictionary (FDx) 410, a conditional probability or a posteriori probability matrix (APM) 420, and a “Knowledge Base System” (KBS) 420. All data in the PRD 401 are date and time stamped. The FDx 410 correlates possible faults in the PV module 300 with a list of observables, a description of symptoms, and possible schemes or methodologies for diagnosing each fault. When underperformance is detected, the FDx 410 is queried to associate the symptoms with the schemes or methodologies to determine one or more possible remedial actions.

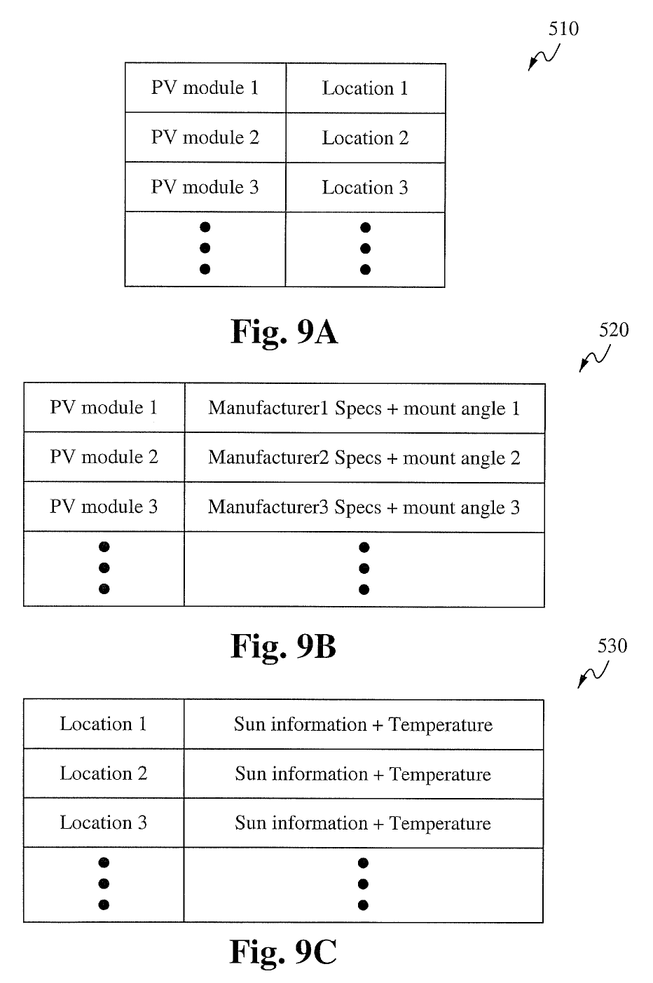

The APM 420 expresses the conditional relationship between various underperformance conditions and an array of possible fault sources. The APM 420 can be accessed and manipulated by algorithms to sort out the most likely faulty conditions from among a list of candidates to be selected and reported. The APM 420 is also affected by the “personality” characteristics as captured by “PV site attribute database elements,” such as shown in FIGS. 9A-C below. While FIG. 6 shows a single APM 420, it will be appreciated that the DWD 400 can contain any number of APMs, such as to simplify storage and updating, speed up processing to determine possible faults, or for any other reason.

The KBS 430 contains entries that correlate causes of underperformance with remedial actions. The KBS 430 stores underperformance information, remedial actions, and related information in a “knowledge representation” format that allows for manipulation by processing algorithms. As one example, the KBS 430 stores data, rules that indicate knowledge, and deduction rules, all manipulated by an induction engine that correlates symptoms, underperformance metrics, and remedial actions. The correlations can be updated and fine-tuned using learning algorithms. For example, it may be determined that a cause of underperformance is more likely than previously thought; the KBS is 430 is updated to reflect this. The underperformance values and corresponding remedial actions can later be stored in different formats, such as in a relational database, that allows for easy storage, retrieval, and display.

The DWD 400 also includes three software programs, a Knowledge Acquisition Module (KAM) 440, a Knowledge Discovery Module (KDM) 450, and a Fault Model Programming (FMP) module 460. The KAM 440 and the KDM 450 function with the KBS 430 to acquire or discover new elements so as to increase or refine the knowledge as it relates to performance issues and characteristics for fault conditions in a solar power plant. The FMP module 460, uses algorithms to develop one or more mathematical models used to receive any combination of measures of underperformance, current weather conditions, and operating characteristics of the PV module 110 and, from them, determine possible causes of underperformance and corresponding remedial actions. The FMP module 460 cooperates with the KBS 430 to account for conditions and to grow and evolve knowledge or algorithms for diagnosing faults. Using heuristics or other learning algorithms, these mathematical models are refined to more accurately predict the possible causes of underperformance, the remedial actions, or both.

The data in the DWD 400 are accessed by a Fault-Diagnostic Inference Engine (FIE), a supervisory program that takes symptoms of underperformance and returns possible causes of underperformance, corresponding remedial actions, or both. FIG. 7 illustrates how an FIE 490 interacts with the DWD 400 in accordance with one embodiment of the invention. The FIE 490 receives as input symptoms of underperformance (e.g., a value of underperformance, such as ΔP, discussed below), uses the input to access the DWD 400, and returns possible causes of underperformance and their remedial actions. The FIE 490, which runs in the Data and Web server 315 (FIG. 4), is always active, triggered whenever any underperformance is detected.

It will be appreciated that the elements described above are only illustrative of one embodiment and that any of the elements can be replaced with a similarly functioning element. For example, the FDx 410 can be replaced with any element that lists faulty components or external factors with attendant symptoms associated with each condition or failure. Similarly, the APM 420 can be replaced with any element that captures conditional probabilities associated with a given symptom of various faulty conditions due to internal failure or external conditions or factors, as accumulated from operational experience, or electrical or physical relationships.

It will also be appreciated that in accordance with embodiments, performance and other data can be collected independently of their analysis. Thus, for example, data can be collected periodically but analyzed in response to specific commands, for particular purposes. When current data is needed, for whatever purpose, a new data collection process can be initiated independently of, and thus without disturbing, any ongoing data processing. The data collection and data analysis components can thus be modular, operating independently of each other.

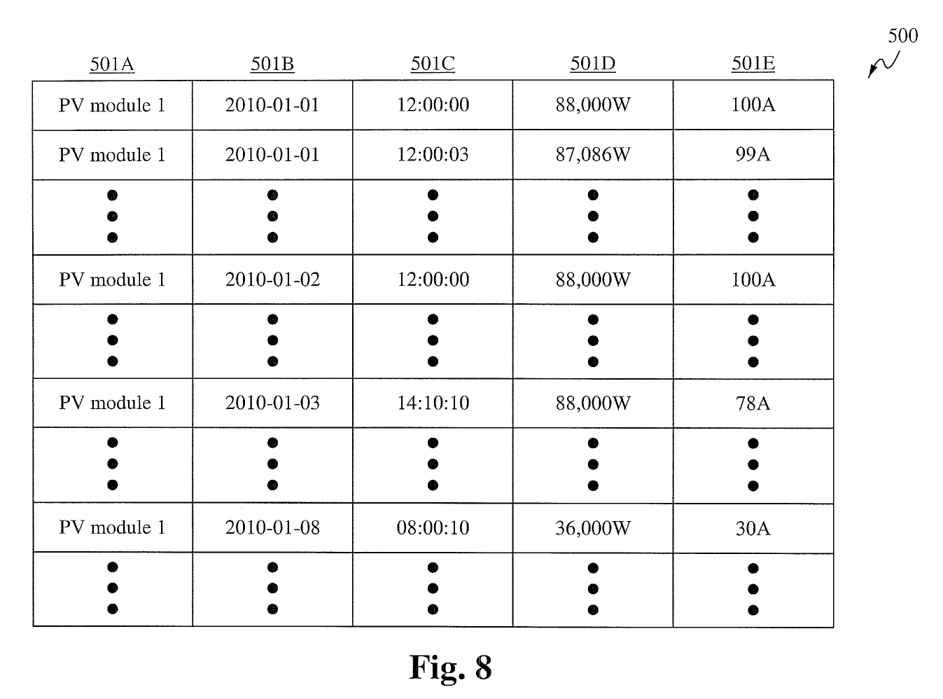

FIGS. 8-11 show tables used to determine underperformance values and corresponding remedial actions, all in accordance with embodiments of the invention. FIG. 8 shows a performance database 500. Each entry (row) includes, in sequential columns 501A-E, a PV module identifier, a date, a time, a measured power output, and a measured current output. Thus, for example, row 1 shows that PV module 1 (column 501A) generated 88,000 W (column 501D) and 100A (column 501E) on Jan. 1, 2010, (column 501B), at 12:00:00 p.m. (column 501C). The next row shows similar information corresponding to 3 seconds later. In one embodiment, the performance data are generated by a CDAQ, such as the CDAQ 113 of FIG. 5.

FIGS. 9A-C show tables in a relational database system used to predict power generated by a PV module in accordance with embodiments of the invention. FIG. 9A shows a table 510 that correlates PV modules with locations. Thus, for example, row 1 of table 510 indicates that PV module 1 is at Location 1. In one embodiment, locations are represented by (longitude, latitude) pairs, or indirectly by city name or zip code. FIG. 9B shows a table 520 that correlates PV modules with manufacturer specifications and mount angles. The specifications for a particular PV module (e.g., power produced for a specific temperature and irradiance) and mount angle (e.g., angle that a PV module is positioned on a roof with respect to the sun at the azimuth) all factor into the power generated by a particular PV module at any particular time of day. FIG. 9C shows a table 530 that correlates locations to information about the sun (such as its angle to the azimuth, its intensity, and total irradiance) and temperature. Again, this information factors into the power generated by a PV module. The table 9C can be populated periodically, such as every minute.

Referring to FIGS. 9A-C, as one example, when a PV module is mounted on a rooftop, its latitude and longitude are entered into table 510, and its manufacturer specifications and mounting angle are entered into table 520. Periodically, such as once a minute, the sun information is updated in table 530. When, as discussed below, a power output is predicted for a PV module, the identifier for the PV module is used to access tables 510 and 520 to determine the location and mount angle of the PV module. The location is then used as a key into table 530 to determine the sun information. The manufacturer's specifications, mount angle, and sun information are all used to determine a predicted output, referred to below as Pₒₚₜ.

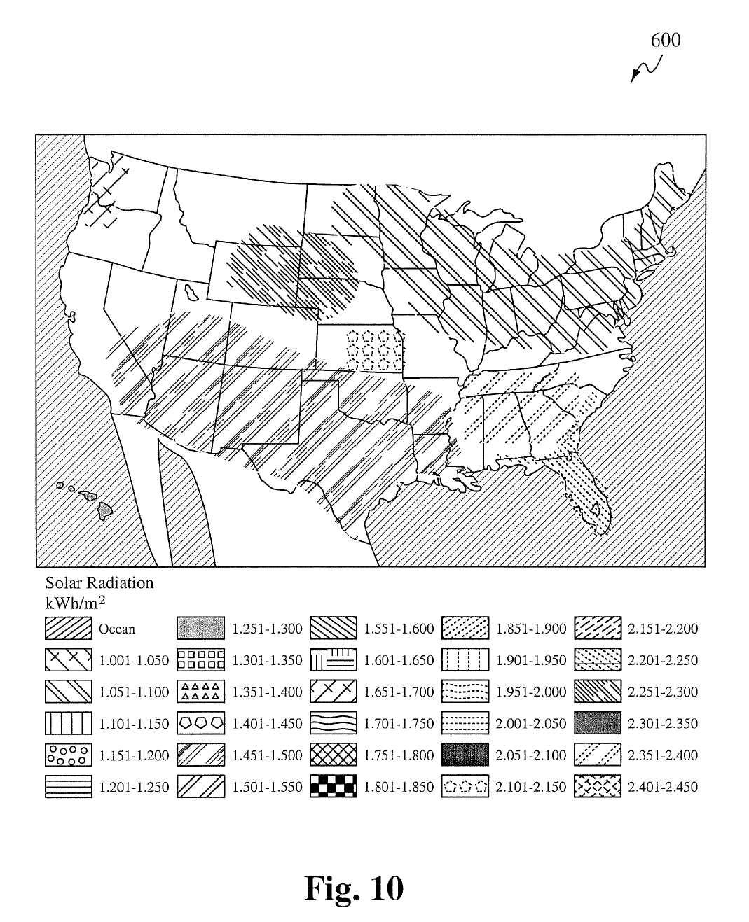

In one embodiment, sun information is determined from an insolation map such as the insolation map 600 in FIG. 10. The insolation map 600 is derived from heat-sensing satellite instruments, indicating the intensity of solar energy impinging on the earth's surface. Insolation maps are available from a number of government and private entities, some free, or with minimal cost. Insolation maps are the basis of PV-Watts, a program developed by National Renewable Energy Laboratories (NREL) to assist with site analysis or partial performance analysis for generic solar sites. Alternatively, site information is determined by querying a weather service, such as over the Internet.

While FIGS. 9A-C show information for multiple PV modules, such as when multiple PV modules are monitored from a central location, in other embodiments information for only a single PV module is stored.

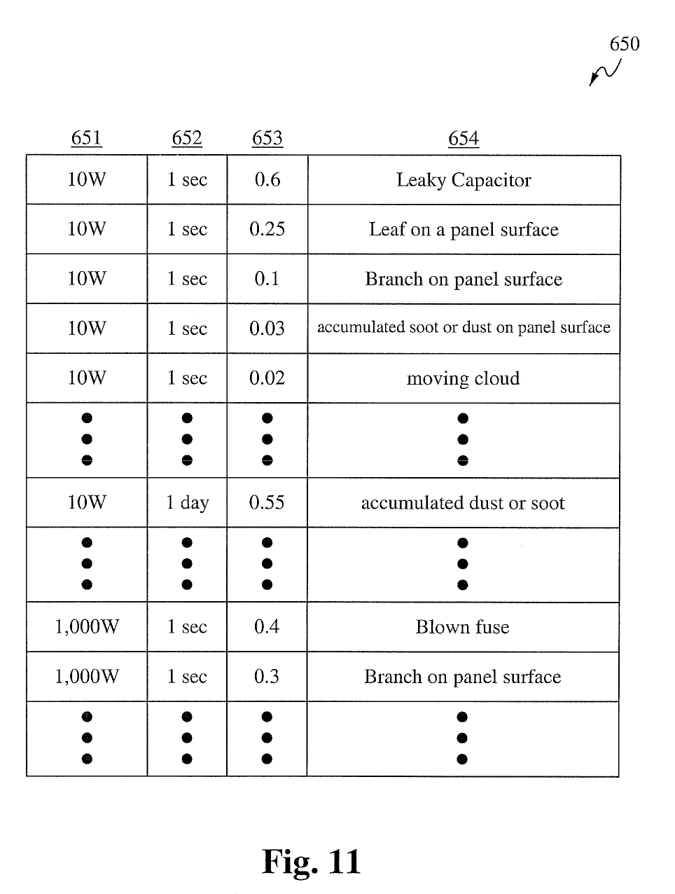

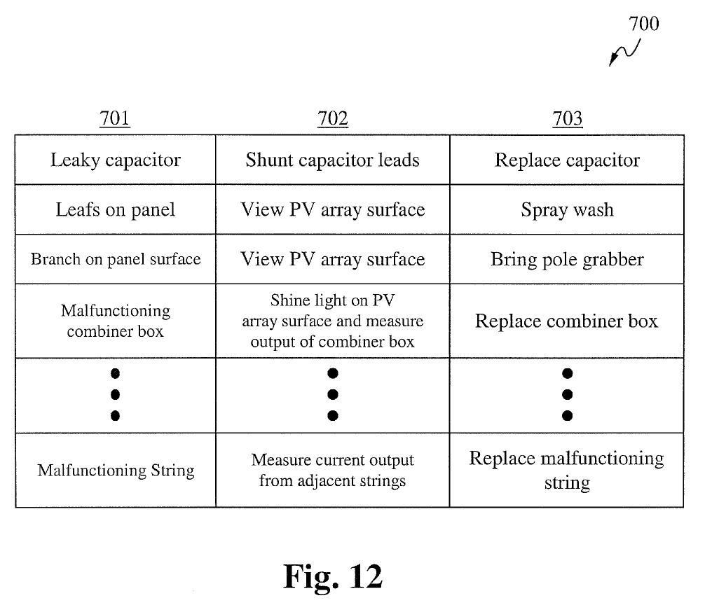

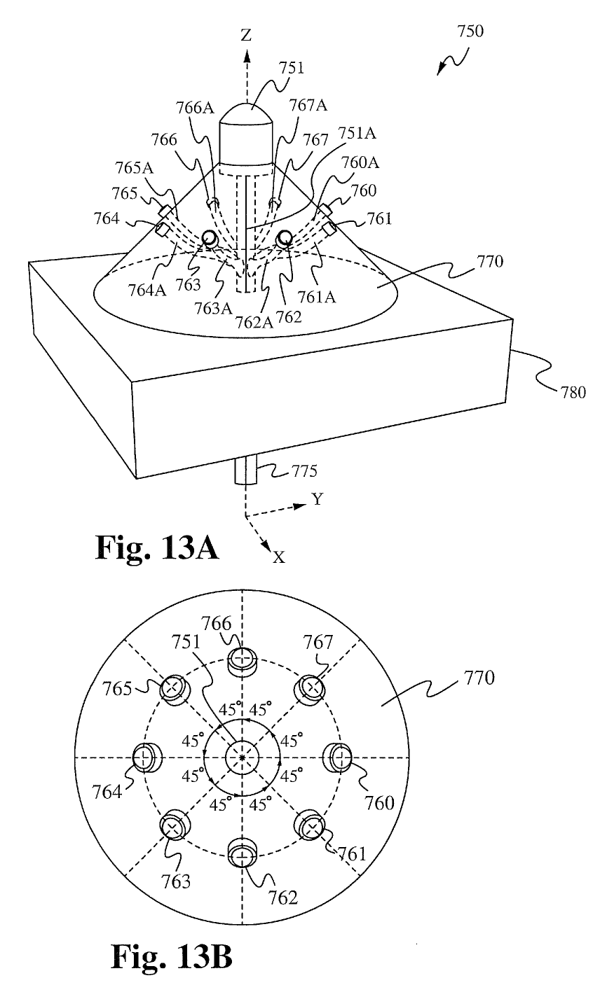

FIGS. 11 and 12 show, respectively, an a priori probability matrix (APM) 650 and a Fault Dictionary (FDx) 700 in accordance with embodiments of the invention. When a measured output of a PV module is smaller than the predicted output by a threshold amount, the amount of underperformance is used to query the APM 650 to determine a possible cause of underperformance, which in turn is used to query the FDx 700 to determine one or more corresponding remedial actions.

Referring to FIG. 11, APM 650 contains multiple entries (rows), each of which includes an amount (metric) of underperformance (e.g., ΔP=Pₒₚₜ−P_{measured})(column 651), a time interval over which ΔP occurred (column 652), and a probability (column 653) that a specific reason (column 654) causes the underperformance. For example, the first entry in table 650 indicates that a ΔP value of 10 W (column 651) over a 1 second interval (column 652) has a 60% probability (column 653) of being caused by a leaky capacitor (column 654). The second entry in table 650 shows that the same ΔP and ΔT have a 25% probability of being caused by the presence of a leaf on a surface of the PV module. The remaining entries in table 650 are similarly explained.

The entries in table 650 can be input in any number of ways, such as by an operator with statistics about causes of underperformance. Later, the entries can be updated automatically by learning algorithms known to those skilled in the art. The entries, or information corresponding to them, can be stored in a knowledge based system (KBS), such as KBS 430 in FIG. 6, which stores the information in a form suitable for knowledge processing. That information can then be translated into elements in the table 650, suitable for quick retrieval and display.

The FDx 700 of FIG. 12 contains multiple entries (rows), each of which includes a cause of underperformance (column 701), a method of diagnosing the cause (column 702), and a remedial action (column 703). For example, the first entry in FDx 700 indicates that a leaky capacitor (column 701) can be diagnosed by shunting the capacitor leads (column 702). If the capacitor is truly leaking, it should be replaced (column 703). The second entry in FDx 700 indicates that leafs on the panel (column 701) can be detected by visually inspecting the surface of the PV array of the underperforming PV module (column 702). If leafs truly are on the surface, the underperformance can be remedied by spray washing the surface (column 703). The remaining entries in FDx 700 are similarly explained.

Still referring to FIGS. 11 and 12, in operation, when underperformance of a PV module is detected, APM 650 is queried to determine the most likely cause. Using the cause, FDx 700 is queried to determine methods to diagnose the cause and corresponding remedial actions. In one embodiment, the diagnostic methods and remedial actions are assembled in a message displayed to monitoring personnel, transmitted to service personnel, or both.

### Examples of Underperformance

The term “underperformance” can refer to any value that reflects a level of operating inefficiency of a PV module. For example, the term can refer to a percentage that the actual (e.g., measured) power (P_{A}) differs from the predicted power. The term can refer to the difference (ΔP), measured in Watts, between an optimal power output (Pₒₚₜ) for a PV unit and P_{A}. The term can refer to a normalized value, such as 1−(Pₒₚₜ−P_{A})/Pₒₚₜ. Those skilled in the art will recognize other values that can be used to measure the operating efficiency or inefficiency of a PV unit.

As used herein, “performance” can be refer to a measure of voltage, current, or power output from a PV module. Those skilled in the art will recognize other measurable parameters that can be used to indicate the performance of a PV module.

### Mathematical Models

In accordance with different embodiments, one or more mathematical models are derived to determine what is variously referred to as an “optimal,” “predicted,” or “benchmark” performance value, such as power output (e.g., Pₒₚₜ, discussed above).

Applying the equivalent circuit theory by Thevenin and Norton, every PV array can be represented by an equivalent circuit for optimally operating the array, nominally derived from a datasheet of every brand and model of PV modules—namely open circuit voltage, short circuit current, maximum power voltage, and maximum power current, all by applying the series and parallel configuration of a PV array. Thus, an equivalent circuit of a well-functioning PV array can be characterized by a region in an IV-Chart, driven continuously by its environmental conditions, but nevertheless quantified mathematically. This dynamically changing region can be referred to as the “sweet spot” for a PV array or power plant. A set of entries in a family of database tables will fully characterize the generic, as well as unique, aspects of a PV site.

Equation (1) below is a mathematical model derived using characteristics for predicting the performance in accordance with one embodiment of the invention, used to determine “underperformance.” When P_{A} varies significantly from the mathematically computed “sweet spot” in Equation (1), the system is considered underperforming.

Pₒₚₜ=S*Cos(Φ)*D*Area(1−(K*(T−25))) Equation (1)
where
S=irradiance
Φ=the incidence angle between an array of PV cells and the position of the sun
D=panel efficiency (usually between 14 and 18 percent, as derived from the manufacturers' datasheet)
Area=total active area of the array of PV cells
K=temperature coefficient of the solar module per datasheet (e.g., 0.5/° C.)
T=temperature of the array of PV cells

The values S, Φ, and T can be measured in any number of ways. As one example, S is measured by a pyranometer mounted alongside the array of PV cells on top of a roof, Φ is determined by the time of day and current month, and T is measured by a thermocouple mounted alongside the array of PV cells. D is a rating, determined for each array of PV cells identified by manufacturer and part number.

Equation (1) estimates Pₒₚₜ by sensing the direct normal component of sunlight. It has been determined that diffused components of sunlight also strike the surface of PV cells. This is especially pronounced on cloudy days, when a larger percentage of light striking a PV array is reflected or diffused light. In accordance with embodiments of the invention, an irradiance sensor is arranged to sense not only the direct normal component of sunlight but also directional diffused components, thereby more accurately detecting more of the energy striking the PV cells and thus more accurately predicting Pₒₚₜ for the solar array.

FIG. 13A is a perspective view of an irradiance sensor 750 in accordance with one embodiment of the invention. The irradiance sensor 750 has a housing that includes a base 770 supporting a funnel mount 770. A rod 775 extends along a central axis (labeled z) of the funnel mount 770 and is topped by a pyranometer 751. Eight photosensors 760-767 are uniformly spaced along the outer surface of the funnel mount 770. As discussed more fully below, the pyranometer 751 and the photosensors 760-767 are all aimed in different directions, outwardly from the surface of the funnel mount 770, arranged to capture direct sunlight and sunlight reflected from clouds, buildings, and other locations.

The pyranometer 751 and photosensors 760-767 all generate signals corresponding to the irradiance striking them. These signals are transmitted along the cables 751A and 760A-767A coupling the pyranometer 751 and photosensors 760-767, respectively, to a processing module (not shown) that translates the signals into a combined irradiance metric for measuring a performance of a PV array.

Referring to the x-y-z coordinate system shown in FIG. 13A, the pyranometer 751 is oriented (e.g., aimed or directed) along the z-axis, and each of the photosensors 760-767 is oriented to make the same angle Θ to the z-axis. Preferably, when installed on a rooftop or other location, the irradiance sensor 750 is mounted so that the z-axis is directed to the sun at its azimuth. In one embodiment, Θ is 45 degrees, but other values of Θ can be used. While each of the photosensors 760-767 is oriented to make the same angle Θ to the z-axis, it will be appreciated that any or all of the photosensors 760-767 can be oriented to make different angles Θ₀, Θ₁, . . . , Θ₇ to the z-axis.

When the z-axis is directed to the sun at its azimuth and the x-y plane is aligned with the horizontal, the angle that a particular photosensor 760-767 makes with the horizontal is referred to as the “elevation” or “tilt” angle. (This angle equals 90−Φ.)

It will be appreciated that the x-y-z coordinate system is shown only for explanation. Other reference systems, oriented in different ways, can also be used to describe the embodiments.

FIG. 13B is a top view of the irradiance sensor 750, taken along the z-axis. Each of the photosensors 760-767 is removed from an adjacent sensor by a 45 degree rotation (angular increment) about the z-axis, such that the angular difference between any two of the photosensors 760-767 is any multiple of 45 degrees between 0 and 345 degrees. In other embodiments, the photosensors 760-767 are spaced in non-uniform angular increments about the z-axis.

The angular rotation about the z-axis for a particular photosensor 760-767, relative to a reference point, is referred to as the “pan angle” (Ω). Together, the tilt and pan angles define a direction.

Preferably, each of the photosensors 760-767 has operational characteristics similar to those of the junction materials in the PV array whose performance is being monitored. In this way, the photosensors 760-767 mimic and thus more accurately track the performance of the PV array. In one embodiment, the photosensors 760-767 are mono crystalline silicon sensors, though other types of sensors can also be used.

It will be appreciated that the photosensors 760-767 can be arranged in any number of ways to capture sunlight reflected from different directions. Furthermore, while the funnel mount 770 has a frusto-conical shape, it will be appreciated that mounts with other shapes configured to direct or aim the photosensors 760-767 outwardly, at different directions, can also be used. In other embodiments, at least some of the photosensors 760-767 are spaced non-uniformly along the outer surface of the funnel mount 770.

In accordance with one embodiment, Pₒₚₜ calculated for a PV array using the irradiance sensor 750 is determined by Equation (2):

Pₒₚₜ=IrrEff*Cos(Φ)*D*Area*(1−K*(Tc−25))*FaultSources Equation (2)
where
IrrEff=Sum[Irr(i)*Cos(Ωi)]
Irr(i)=i-th sensor (e.g., 760-767) mounted at the Ωi incidence angle (i=0 to 7), where Ωi (any one or more of which can be complex) varies from 0 to 359 degrees, as needed, to capture the commonly missed energy components
Φ=the incidence angle between an array of PV cells and the position of the sun
D=panel efficiency (usually between 14 and 18 percent, as derived from the manufacturers' datasheet)
Area=total area of the array of PV cells
K=temperature coefficient of the solar module per datasheet (e.g., 0.5)
T=temperature of the array of PV cells
FaultSources=All known sources of external factors that impact the array output (e.g., sources stored in the Table 650 of FIG. 11)

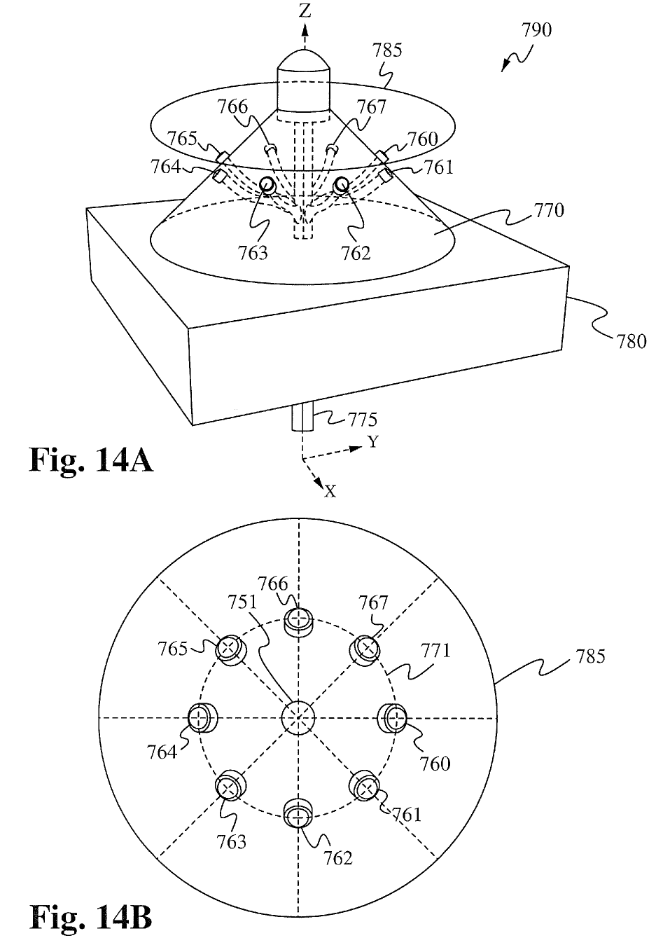

It has been determined that the accuracy of irradiance measurements is increased by substantially limiting one set of light sensors to measure direct normal sunlight and another set to measure indirect, diffused light. In accordance with one embodiment, FIG. 14A is a perspective view of an irradiance sensor 790, and FIG. 14B is a top view taken along the z-axis. The irradiance sensor 790 includes all the components of the irradiance sensor 750 but also has a collar (e.g., light shield or light shade) 785 positioned between the pyranometer 751 and the photosensors 760-767. (For clarity, the labels 751A and 760A-767A are not included in FIGS. 14A and 14B.) The light shield 785 is opaque and arranged to substantially shield the photosensors 760-767 from sunlight as the sun traces an arc that includes a normal to the pyranometer 751. In one embodiment, the arc spans 45 degrees. Thus, when the sun is within this arc, the sunlight falls almost exclusively upon the pyranometer 751. Diffuse sunlight outside that range, such as that reflected from clouds and buildings, falls upon the photosensors 760-767.

It will be appreciated that the light shield 785 can have different configurations and still achieve the principles of the invention. In the embodiment of FIGS. 14A and 14B, the horizontal surface of the light shield 785 is substantially perpendicular to the rod 775. In one embodiment, the light shield 785 has a radius of 4 inches, a circle 771 centered on the z-axis and delimited by the photosensors 760-767 has a radius of 2 inches, and the circle 771 and the light shield 785 are 1.25 inches apart. As shown in FIG. 14B, the light shield 785 entirely overlies the circle 771. It will be appreciated that the components can have other dimensions and can be arranged in different ways. For example, the surface of the light shield 785 can make other angles with the rod 775 and can have other shapes, so long as it substantially shields the photosensors 760-767 from direct sunlight in the manner discussed here.

Preferably, the light shield 785 includes an opaque material. Also preferably, the light shield 785 is constructed to withstand temperature extremes, precipitation, wind, and other outdoor conditions. As one example, the light shield 785 comprises stainless steel with an anti-reflective coating. Those skilled in the art will recognize other suitable materials for the light shield 785.

The light shield 785 can be temporarily removed for calibration or during troubleshooting or maintenance operations.

In different embodiments, the irradiance sensor 750 or the irradiance sensor 790 replaces the irradiance sensor 145 shown in FIG. 3.

The irradiance sensors 750 and 790 leverage the power of embedded computing and intelligent server resources to capture direct and diffused energies from the sun. Preferably, the irradiance sensors 750 and 790 contain no moving parts and thus are low-cost approaches for sensing light energy.

### Model Parameters

Every PV power plant site is uniquely defined by a set of characteristics such as location-latitude and longitude, mounting of the individual PV modules, brand and model of the PV modules, and micro-climate of the site, to name only a few characteristics. This “personality,” sometimes characterized qualitatively, other times quantitatively, is used to determine any operating abnormalities.

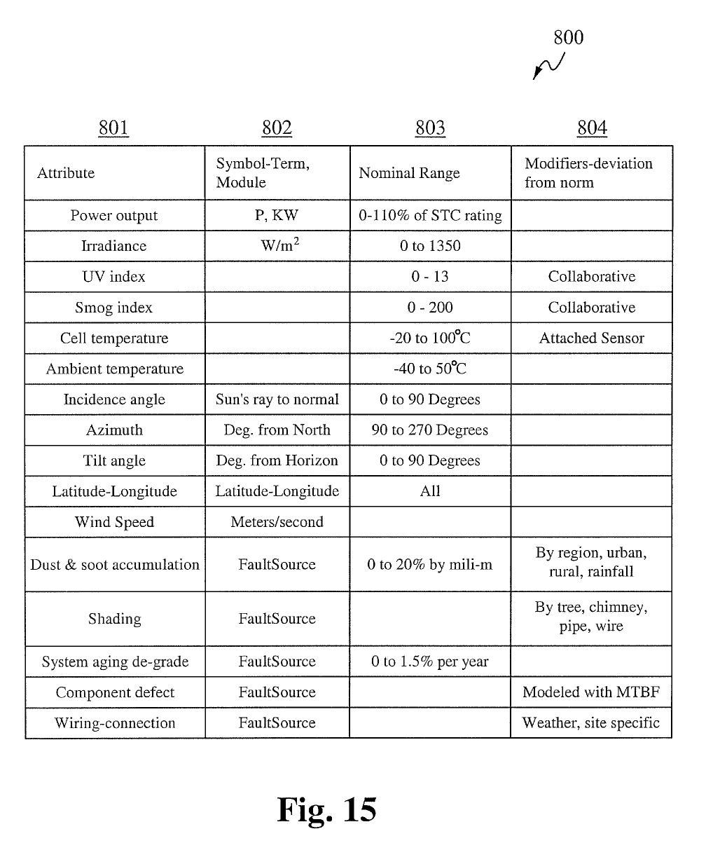

FIG. 15 shows a table 800 that includes mathematical model parameters for predicting instantaneous power output (e.g., Pₒₚₜ) for a PV module using Equation (1), in accordance with embodiments of the invention. (While some of the following examples discuss Equation (1), the principles apply equally to Equation (2).) Table 800 shows, in columns 801-804 respectively, (1) attributes, (2) symbol terms or modules, (3) nominal ranges, and (4) modifiers or deviations from the norm. Referring to each entry (row) in turn, table 800 includes the attribute “Power Output,” which has a nominal range of 0 to 110% of Standard Test Conditions (STC) rating; an irradiance, which has a nominal range of 0 to 1,350 W/m²; a UV index, which has a nominal range of 0 to 13; a smog index, which has a nominal range of 0 to 200; a cell temperature, which has a nominal range of −20° C. to 100° C.; an ambient temperature, which has a nominal range of −40° C. to 50° C.; an incidence angle (sun's ray to normal), which has a nominal range of 0° to 90°; an azimuth (degrees from North), which has a nominal range of 90° to 270°; a tilt angle (degrees from the horizon), which has a nominal range of 0° to 90°; a latitude and longitude; a wind speed; a dust and soot accumulation value, which has a nominal range of 0 to 20% by millimeter; a shading; a system aging degradation value, which has a nominal range of 0 to 1.5% per year; a component defect value; and a wiring-connection value.

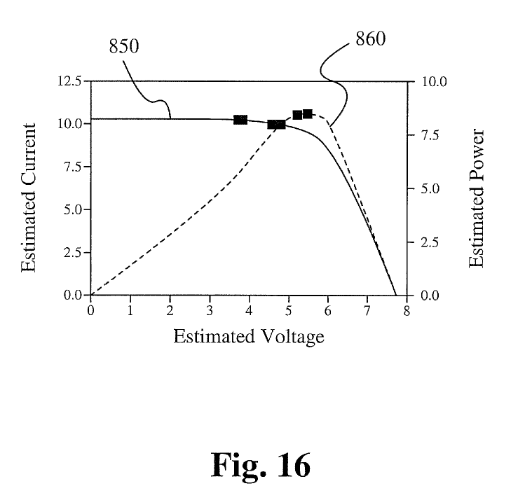

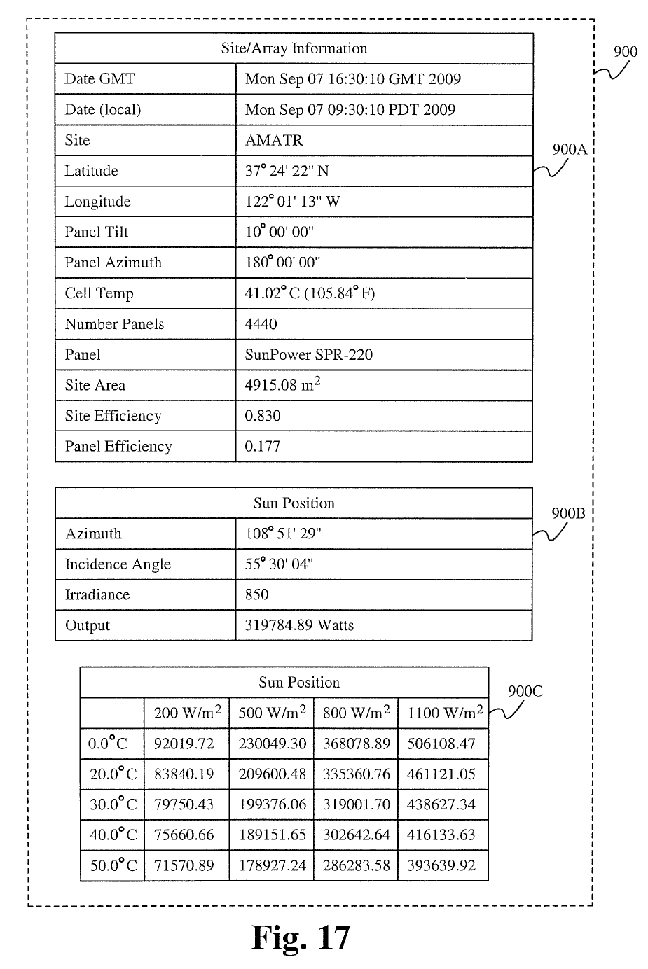

The entries in table 800 are all taken into account when modeling Equation (1). FIG. 16 shows two graphs, the first graph 850 plotting estimated current (on the y-axis) versus estimated voltage (on the x-axis), the second graph 860 plotting estimated power (on the y-axis) versus estimated voltage (on the x-axis), both generated using Equation (1). The two graphs 850 and 860 are used to compare the ideal macro-IV Chart and Fault Condition. Superimposed on the graph 850 are points () showing the actual current and voltage measured on a PV module. Superimposed on the graph 860 are points (▪) showing the actual power measured on the PV module. The smaller the distances between (1) the points () and the graph 850 and (2) the points (▪) and the graph 860, the more accurate Equation (1). The accuracy of Equation (1) can be increased by adjusting its parameters, thereby refining components that rely on it, such as the fault-detection, fault-modeling, and fault-diagnosing programs used in accordance with embodiments of the invention.

The benchmark output in power, voltage, or current (and thus Equations (1) and (2) above) is based on different parameters, such as the materials from which the PV module is made, the test conditions used to rate the performance of the PV module, and other factors, all of which are discussed below.

### Materials and Composition

Among other things, the performance of a PV module depends on the module material. The conversion efficiency of amorphous silicon modules varies from 6% to 8%. Modules of multi-crystalline silicon modules have a conversion efficiency of about 15%. Mono-crystalline silicon modules are the most efficient, with a conversion efficiency of about 16% to 24%. Modules are roughly 1 m² to 1.5 m² in area, and getting larger, and typically include between 36 and 72 individual PV cells.

### Standard or Practical Test Conditions

The DC output of solar modules is rated by manufacturers under Standard Test Conditions (STC). These conditions are easily recreated in a name-plate and allow for consistent comparisons of products, but they must be modified to estimate output under common ambient operating conditions. STC conditions include a solar module temperature of 25° C.; a solar irradiance (intensity) of 1,000 W/m² (often referred to as peak sunlight intensity, comparable to clear summer noon-time intensity); and a solar spectrum as filtered by passing through 1.5 times normal of atmosphere (ASTM Standard Spectrum). A manufacturer can rate a particular solar module output at 200 Watts of power under STC and call the product a “200-watt solar module.” This module will often have a production tolerance of +/−5% of the rating, which means that the module can produce 190 Watts and still be called a “200-watt module.”

FIG. 16, a graphical presentation of the current versus the voltage (I-V curve) from a photovoltaic module, was generated by rapidly sampling of array voltage and current values. The shape of the curve characterizes module performance; this can be called “name-plate performance” or performance of a PV module under specified operating conditions.

### Light Energy Spectrum Response

The electrical current generated by photovoltaic devices is also influenced by the spectral distribution (spectrum) of sunlight. It is also commonly understood that the spectral distribution of sunlight varies during the day, being “redder” at sunrise and sunset and “bluer” at noon. The magnitude of the influence that the changing spectrum has on performance can vary significantly, depending on the PV technology being considered. In any case, spectral variation introduces a systematic influence on performance that varies by time-of-day. Similarly, the optical characteristics of PV modules or pyranometers can result in a systematic influence on their performance related to the solar incidence angle.

### Cell Temperature

Since roughly 80% of the sun's energy is dissipated into heat, PV module output power reduces as the module temperature increases. When operating on a roof, a solar module will heat up substantially, reaching inner temperatures of 50° C. to 75° C. For crystalline modules, a typical temperature reduction factor recommended by the California Energy Commission is 89% or 0.89. Therefore, the 200-Watt solar module will typically operate at about 170 Watts (190 Watts*0.89=170 Watts) in the middle of a spring or fall day, under full sunlight conditions. To ensure that PV modules do not overheat, they must be mounted in such a way as to allow air to move freely around them. This is particularly important in locations that are prone to extremely hot midday temperatures. The ideal PV module operating conditions are cold, bright, sunny days.

### Dust or Soot

Dust or soot can accumulate on the PV module surface, blocking some of the sunlight and thus degrading output. Although typical dust is washed away during rainy seasons, it is more practical to estimate system output taking into account the reduction due to dust buildup in the dry season. A typical annual dust reduction factor is approximately 5% or 0.95. Therefore, a 200-Watt solar module operating with some accumulated dust may operate, on average, at about 79 Watts (170 Watts*0.93/2=158 Watts/2).

A 1.6 GW STC group of grid-tied solar arrays (as specified under STC conditions) located on the Googleplex in Mountain View, Calif., U.S.A., was studied by a team at Google and publicized. As confirmed by the study, layers of dust or soot that accumulate over time may degrade the PV module's output by as much as 7%. The mathematical models of Equations (1) and (2) can thus be enhanced with an element that represents the accumulated layer of dust, with modifiers for a region's dust and rainfall characteristics, which can be tracked and modified by the occurrence of rainfall or cleaning. A nominal 0.1% degradation may be used as baseline model, for every week that goes by without any intervening event, such as rain or high winds.

### Mismatch and Wiring Losses

The maximum power output of a total PV module is always less than the arithmetic sum of the maximum output of the individual modules. This difference is a result of inconsistencies in performance among modules, and is called “module mismatch,” which can result in roughly 2% loss in system power. Power is also lost due to resistance in the system wiring. These losses should be kept low with proper wire-sizing and good workmanship, but it is often difficult to keep them below 3%. A common derating factor for these losses is 95%.

### DC-to-AC Conversion Efficiency

The DC power generated by the solar module must be converted into common household AC power using an inverter. Some power is lost in the conversion process, and there are additional losses in the wires from the rooftop array, down to the inverter, and out to the house panel. Modern inverters commonly used in residential PV power systems have peak efficiencies of 92% to 94%, as indicated by their manufacturers, but these again are measured under well-controlled name-plate conditions. Actual field conditions usually result in overall DC-to-AC conversion efficiencies of about 88% to 92%, with 90% or 0.90 a reasonable compromise. Thus, a 200-Watt solar module output, reduced by production tolerance, heat, dust, wiring, AC conversion, and other losses should translate into about 136 Watts of AC power delivered to the house panel during the middle of a clear day (200 Watts*0.95*0.89*0.93*0.95*0.90=134 Watts).

### Calculating System Power Output

The PV module should be positioned and mounted to absorb the most energy from the sun. If the photovoltaic modules have a fixed position, their orientation with respect to the south (northern hemisphere), and tilt angle, with respect to the horizontal plane, should be optimized. For grid-connected PV systems in the U.S., for instance, the optimum tilt angle is about 25 degrees. For regions nearer to the equator, this tilt angle will be smaller, and for regions nearer the poles, it will be larger. The output from the array will rise gradually from 0, during dawn hours, increase with the sun angle to its peak output at solar noon, and then gradually decrease into the afternoon and back down to 0 at night. While this variation is due in part to the changing intensity of the sun, the changing incidence angle also has an effect. The pitch of the roof or tilt angle or structural frame will affect the sun angle on the PV module plane (e.g., angle θ in FIG. 1), as will the azimuth orientation of the roof. These effects and others are all taken into account by the mathematical model in table 800 in FIG. 15.

### Display Mechanism

Performance information, remedial actions, and other types of data measured and generated in the embodiments can be displayed in any number of ways. Messages can be transmitted for display to the building to which the PV module is mounted, to a central location used to monitor multiple PV modules at geographically dispersed locations, to a repair person making rounds, or to any other person or location. The information can be transmitted over local area networks, over the Internet, using wireless transmissions such as WiFi or cellular, to a cell phone or personal digital assistant, or by any other means.

Preferably, messages are categorized according to the amount that the output is degraded, the amount of underperformance. As one example, a message is categorized as an “alert” when system performance is 10% below the norm, as a “warning” when system performance is 20% below the norm, and as an “alarm” when system performance is 30% or more below the norm. With these categorizations, service personnel can quickly determine in what order and how quickly sites must be serviced. When the system performance is within acceptable limits, such as no more than 5% below the norm, an “OK” message, along with a relative percentage of the benchmark level, is transmitted, thereby letting operators know that the notification system is functioning. Of course, other thresholds based on other percentages of degraded output can also be used.

In one embodiment, one or more Web pages or other electronic textual elements display various parameters used to track the performance of a PV site such as:
solar irradiance
cell temperature, such as measured using one or more sensors attached to a back of a solar module
time-of-day
photovoltaic power production in kW
photovoltaic power (kW) relative to utility-provided electrical power plants
photovoltaic power (kW) on a time scale, total photovoltaic power production
daily power production (kW), power production relative to utility power consumption
solar power production (kW) over the lifetime of the PV module
daily solar production relative to maximum possible production, and
a benchmark bar graph illustrating the current day's solar electricity production, hour-by-hour

Preferably, a user is presented with information that allows him to track the output of a PV module or PV power plant and understand why the PV module or PV power plant is not performing as expected. FIG. 17 is a Web page 900 generated in accordance with one embodiment of the invention, showing Tables 900A-C. The Table 900A contains site and array information including the date, both Greenwich Mean Standard and local, a site identifier, a latitude and longitude, a panel tilt angle, a panel azimuth, a cell temperature, the number of panels at the PV site, the panel identifier by manufacturer and part number, the site area, the site efficiency, and the panel efficiency. The Table 900B contains sun position information including azimuth, incidence angle, irradiance, and output. The Table 900C is a PV Performance Lookup Table showing Pₒₚₜ values calculated according to Equation (1), for a particular value of the irradiance angle Φ, 55° 30′ 04″.

### Web Services

In some embodiments, customers can subscribe to Web services offered in accordance with the embodiments. With this service, a central site operator monitors PV arrays at a customer site and provides the customer with one-time or periodic reports detailing the performance of the PV arrays. The customer can select the type of performance data included in the reports.

### Virtual Visit Solar Site Assessment Reporting

In some instances, the actual irradiance striking a PV array cannot be determined. For example, a location is too remote for personnel to install an irradiance sensor adjacent to PV arrays. In accordance with one embodiment, a mathematical model (e.g., Equations (1) and (2), above) is generated using parameters other than the irradiance, such as air temperature or other environmental data surrounding or sufficiently close to the location being monitored. The location is thus “virtually” visited. In one embodiment, agent-like programs are dispatched to harvest environmental data surrounding an area and used to approximate modeling parameters.

### Examples of Determining Underperformance

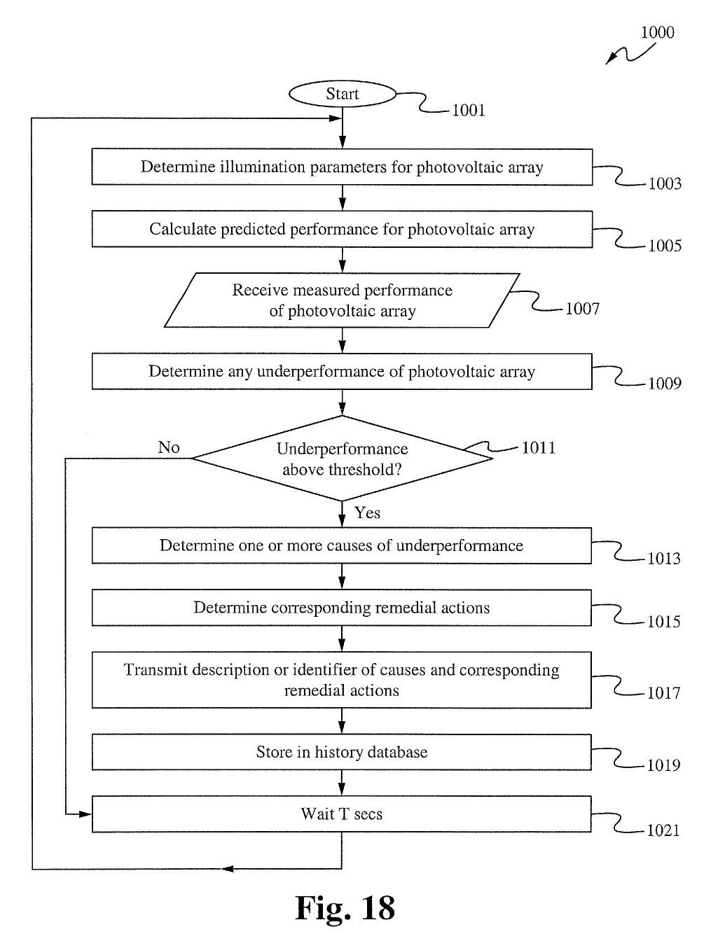

FIG. 18 shows the steps 1000 of a process for detecting underperformance and determining corresponding remedial actions in accordance with embodiments of the invention. The process starts in the step 1001 in which any parameters are initialized. In the step 1003, the process determines illumination parameters for a PV module by accessing table 510 (to read the location of the PV module) and table 530 (to retrieve the sun information), in FIGS. 9A and 9C, respectively. Next, in the step 1005, the process uses the illumination parameters and PV module characteristics from table 520 (FIG. 9B) to predict the performance for the PV module (Pₒₚₜ) using Equation (1) or (2) above. In the step 1007, the process determines the actual (measured) performance of the PV module (P_{A}) from Table 500 in FIG. 8. In the step 1009, the process compares the actual performance and the predicted performance to determine any underperformance (ΔP=Pₒₚₜ−P_{A}). In the step 1011, the process determines whether the underperformance (ΔP) is greater than a threshold level. As one example, the threshold level is a 5% difference. If the underperformance is greater than the threshold, then the process continues to the step 1013; otherwise, the process continues to the step 1021.

In the step 1013, the process accesses Table 650 in FIG. 11 to determine one or more causes of underperformance. Preferably, the process selects the most likely cause of underperformance, such as determined from column 653 in FIG. 11. Alternatively, multiple causes, arranged from most likely to least likely, are selected. In the step 1015, the process uses the one or more causes of underperformance to access the Table 700 in FIG. 12 to determine one or more diagnostic tests, remedial actions, or both. In the step 1017, the process transmits a description of the causes, diagnostic tests, remedial actions, or any combinations of these to a display. In the step 1019, the one or more causes are stored in a history database. In the step 1021, the process waits T time units and then returns to the step 1003. As one example, T is 1 second, though any other time unit can be used.

In alternative embodiments, the step 1017 is supplemented with the step of automatically taking the remedial action. As one example, when the remedial action is spray washing a surface of the PV module, this action is taken automatically by triggering a rooftop sprinkler system to wash away leaves or other debris. Those skilled in the art will recognize other remedial actions that can be taken automatically.

It will be appreciated that the steps 1000 of FIG. 18 are merely exemplary. Some of the steps can be deleted, other steps can be added, and the steps can be performed in different orders.

It will be appreciated that references to “cause of underperformance” and “remedial action” can refer to single or multiple causes and remedial actions. Each is referred to in the singular merely to simplify the discussion.

In one embodiment, the steps 1000 are performed by a processor executing instructions on a computer-readable medium. In different embodiments, the computer-readable medium is programmed using software, hardware, firmware, any other means for executing instructions, or any combination of these. It will be appreciated that the functionality shown in FIG. 18 can be distributed among the different components and locations in any number of ways. For example, underperformance can be determined at the structure on which the PV module is mounted or at a central location. Considerations include the distribution of processing loads, the desire to reduce the amount of information that must be transmitted over the Internet, down Internet connections, and the like.

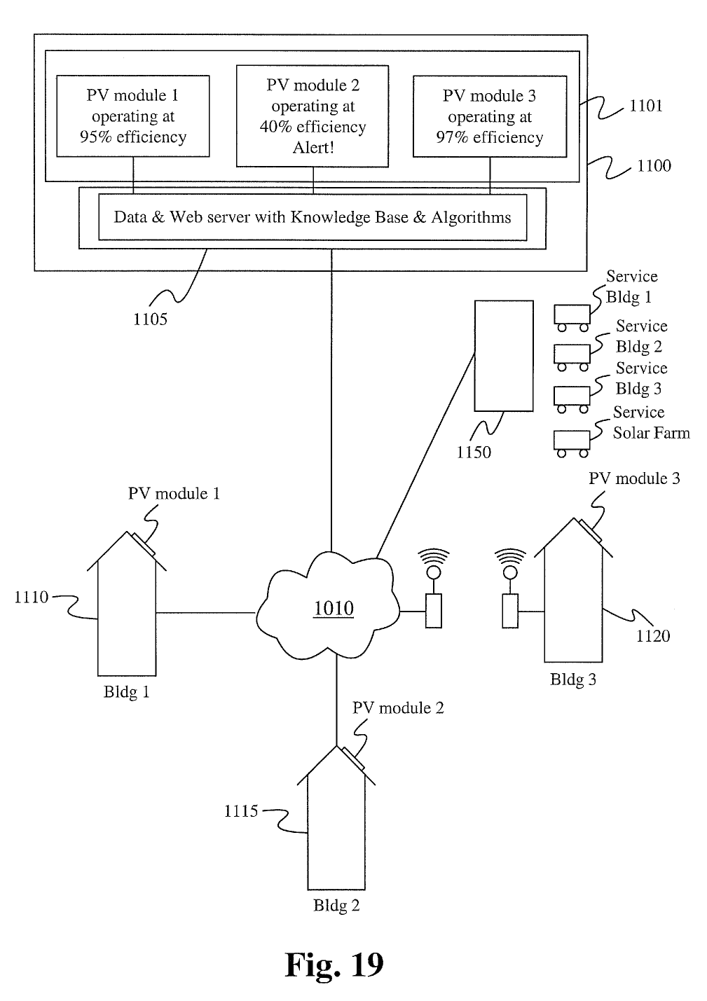

While the examples discussed above illustrate monitoring a single PV array at a single location, it will be appreciated that multiple PV modules at different geographic locations can be monitored at a one or more central locations. FIG. 19 shows a system 1100 for centrally monitoring multiple PV modules at different sites 1110, 1115, and 1120, and dispatching service personnel to each, such as from a service distribution site 1150. The system 1100 includes a Web page display unit 1101 and a database management system (DBMS) 1105 that includes a Data and Web server with KnowledgeBase & Algorithms, such as discussed above. The system 1100 includes one or more processors and computer-readable media for performing the algorithms (e.g., the steps 1000 in FIG. 18) discussed herein. The system 1100 is configured to receive actual performance values from a PV module (e.g., power, current, or voltage generated, or any combination of these) over the Internet, over a LAN, using wireless communications such as WiFi, or using any other communications means. The DBMS 1101 calculates any underperformance of PV modules 1-3, and determines causes of underperformance and any remedial actions.

The Web page display unit 1101 shows information for the PV modules 1-3, respectively, similar to that includes in the Web page 900 in FIG. 17. The system 1100 also transmits messages to service personnel at the distribution site 1150 or in the field. The messages, similar to the “alert,” “warning,” and “alarm” messages discussed above, include the location of a PV module, the amount of underperformance, a cause of underperformance, possible diagnostic schemes, and one or more remedial actions for the service personnel to take.

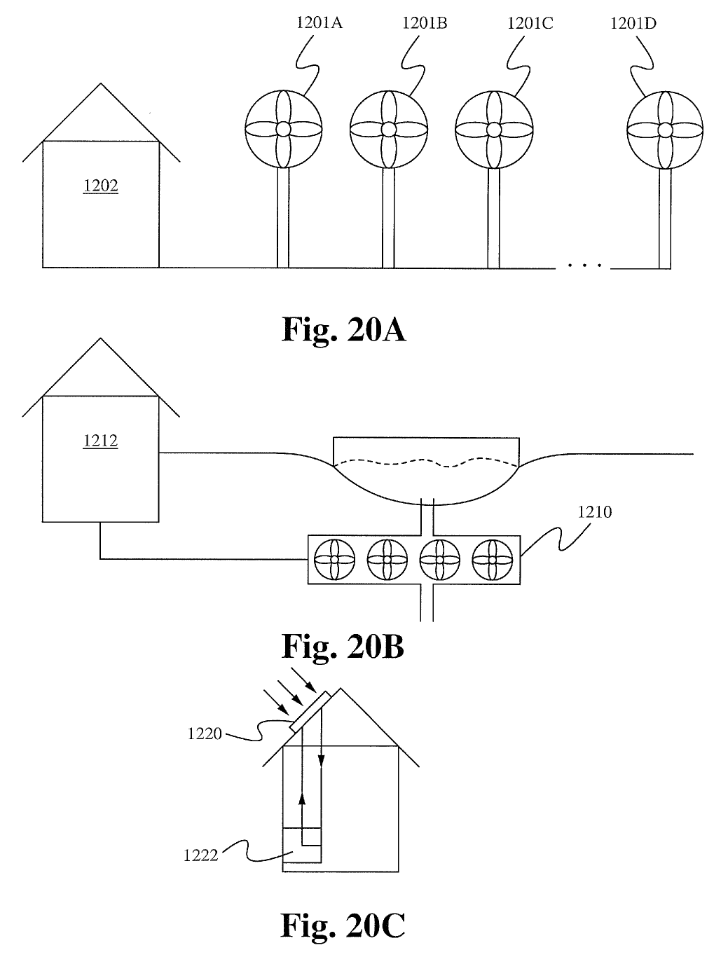

While the examples above describe PV modules, it will be appreciated that the principles of the invention are suitable for monitoring the output of other types of energy conversion units. FIG. 20A, for example, shows a wind farm that includes multiple wind turbines 1201A-D that provide electrical power to a building 1202. Possible causes of underperformance are the presence of branches or other obstacles in the turbine blades, theft or vandalism of components of the wind turbines, dust on the blades, and the like. FIG. 20B shows a hydro-electric system 1210 that includes multiple micro-hydro turbines that provide electrical power to a building 1212. Possible causes of underperformance are the presence of branches or rocks clogging the inlet or upstream obstructions to water flow. FIG. 20C shows a solar heating system that includes a collector 1220 and a storage tank 1222. In accordance with embodiments of the invention, the wind turbine, hydro-electric, and solar water heating systems of FIGS. 20A-C, respectively, each includes systems that determine underperformance, possible causes of underperformance, diagnostic schemes, corresponding remedial actions, and means for displaying or transmitting each of these elements, such as described throughout this application.

In accordance with embodiments of the invention, multiple PV modules are mounted to rooftops at sites at different geographic locations. For each PV array, information is stored at a central location, information such as location (e.g., latitude and longitude), operating specifications for the PV module, and orientation relative to the sun's azimuth angle for the location. A mathematical model used to predict performance (e.g., power output) for each PV module is generated. The predicted performance is based on the current time and the current weather conditions surrounding the PV module, including the intensity of the sun, cloud cover, wind speed, and the like. Preferably, the predicted performance is modeled, for example, using Equation (1) or Equation (2) above. The central location also houses a database populated with possible causes of underperformance, diagnostic methods, and remedial actions.

In operation, the output of each PV module is periodically measured and transmitted to the central location. At the central location, performance information for each PV array is displayed to monitoring personnel. The measured performance is compared to the predicted performance, and if the difference between the two is above a threshold value, the system determines that the PV module is underperforming.

The amount of underperformance is used, with other variables such as the current weather and output history of the PV module, to determine diagnostic strategies and remedial actions. The diagnostic strategies and remedial actions are explained in messages transmitted to service personnel who are dispatched to service the underperforming PV arrays. In this way, the output of the PV arrays can be maintained at optimal levels; preferably, any diminished output levels are restored.

In one embodiment, the predicted performance is based on irradiance measured at each site. The irradiance is determined by an irradiance sensor having a pyranometer directed to the sun at its azimuth and multiple photosensors directed at various angles relative to the pyranometer. An opaque light shield is located between the pyranometer and the multiple photosensors.

After service personnel have visited sites, they input data indicating the actual causes of underperformance, strategies they used to determine the actual causes of underperformance, and the actual diagnosed cause of underperformance. This updated data is used by learning systems and other artificial intelligence components to update and refine the mathematical models (e.g., the coefficients of the mathematical models) and the databases that correlate the underperformance metrics, the causes of underperformance, the diagnostic strategies, and the remedial actions.

After reading this application, those skilled in the art will recognize many possible variations within the spirit of the invention. For example, a table of the causes and remedial actions can be stored on a device carried by service personnel. In this way, rather than transmitting text describing the causes of underperformance and corresponding remedial actions to service personnel, only the indices corresponding to the table entries need to be transmitted. It will be readily apparent to one skilled in the art that other modifications may be made to the embodiments without departing from the spirit and scope of the invention as defined by the appended claims.

We claim:

1. A system for monitoring an efficiency of an energy converter comprising:
a module configured to determine an amount that an output of the energy converter differs from a predicted output for the energy converter.

2. The system of claim 1, wherein the module is also configured to determine a possible cause of underperformance for the energy converter, a strategy for diagnosing the possible cause of the underperformance, a corresponding remedial action, or any combination thereof.

3. The system of claim 1, wherein the predicted output is based on operating conditions of the energy converter.

4. The system of claim 3, wherein the operating conditions comprise a current time of day, a current month, or both.

5. The system of claim 3, wherein the operating conditions correspond to a microclimate surrounding the energy converter.

6. The system of claim 3, wherein the module is also configured to receive the operating conditions from a weather monitoring system over the Internet.

7. The system of claim 1, further comprising a monitor for measuring the output of the energy converter.

8. The system of claim 1, further comprising a transmission module for notifying an agent when an underperformance metric of the energy converter exceeds a predetermined threshold.

9. The system of claim 1, wherein the energy converter comprises one or more photovoltaic cells, one or more solar heating units, one or more wind turbines, or one or more water turbines.

10. The system of claim 2, wherein the predicted output, the possible cause of the underperformance, a strategy for diagnosing the possible cause of underperformance, the corresponding remedial action, or any combination thereof are automatically determined using a learning algorithm.

11. A system for monitoring an efficiency of a photovoltaic array comprising:
a monitor configured to measure an output of the photovoltaic array; and
a first module configured to determine an amount the output differs from a predicted output of the photovoltaic array.

12. The system of claim 11, wherein the first module is also configured to determine a possible cause of underperformance for the photovoltaic array, a strategy for diagnosing the possible cause of underperformance, a corresponding remedial action, or any combination thereof.

13. The system of claim 12, wherein a possible cause of underperformance includes theft or vandalism of a component of the photovoltaic array, a fault in the photovoltaic array, a presence of an object blocking illumination to the photovoltaic array, or any combination thereof.

14. The system of claim 11, wherein the predicted output is determined from illumination parameters of the photovoltaic array.

15. The system of claim 14, wherein the illumination parameters are related to a microclimate for the photovoltaic array.

16. The system of claim 15, wherein the first module is also configured to receive microclimate information from a weather monitoring system over the Internet.

17. The system of claim 14, wherein the illumination parameters comprise a current time of day, a current month, and an incidence angle of illumination on the photovoltaic array.

18. The system of claim 11, wherein the predicted output is determined from an amount of irradiation striking the photovoltaic array, an incidence angle of irradiation striking the photovoltaic array, a temperature of the photovoltaic array, or any combination thereof.

19. The system of claim 11, wherein the predicated output is based on predetermined operating characteristics of the photovoltaic array.

20. The system of claim 11, further comprising a second module configured to receive the measured output and transmit an underperformance value, a cause of underperformance, a strategy for diagnosing the cause of underperformance, a corresponding remedial action, or any combination thereof to an agent.

21. A system comprising:
a first module configured to determine underperformance values of multiple energy conversion units in multiple different geographic locations; and
a second module configured to determine for each of the underperformance values a possible cause of underperformance, a strategy for diagnosing a cause of the underperformance, and a corresponding remedial action.

22. The system of claim 21, wherein the first module monitors outputs from each of the multiple energy conversion units to determine the underperformance values.

23. The system of claim 21, wherein the second module monitors current microclimates surrounding each of the multiple energy conversion units to determine the underperformance values.

24. A method of monitoring a performance of an energy converter comprising:
determining an underperformance for the energy converter; and
determining a remedial action for increasing the output.

25. The method of claim 24, wherein determining the underperformance comprises comparing an output of the energy converter to a predicted output of the energy converter.

26. The method of claim 25, wherein the predicated output is based at least on a current microclimate surrounding the energy converter.

27. The method of claim 26, further comprising receiving information over the Internet to determine the current microclimate.

28. The method of claim 24, further comprising determining a strategy for diagnosing a possible cause of underperformance.

29. The method of claim 28, further comprising determining a possible cause of the underperformance.

30. The method of claim 29, further comprising determining a remedial action corresponding to the possible cause of the underperformance.

31. The method of claim 24, further comprising transmitting to an agent information identifying a possible cause of the underperformance, a corresponding remedial action, or both.

32. The method of claim 24, wherein a possible cause of underperformance, a strategy for diagnosing the possible cause, a corresponding remedial action, or any combination thereof is automatically updated using a learning algorithm.

33. The method of claim 24, wherein the energy converter comprises one or more photovoltaic cells, one or more solar heating units, one or more wind turbines, or one or more water turbines.

34. A device comprising:
multiple light detectors directed in different directions, wherein the device is configured to determine irradiance impinging on the multiple light detectors.

35. The device of claim 34, wherein a portion of the multiple light detectors are directed outwardly at different angles about a central axis.

36. The device of claim 34, wherein the different directions comprise a first direction along a vector and second directions at one or more angles to the vector.

37. The device of claim 34, wherein the multiple light detectors comprise a pyranometer directed in the first direction and multiple photosensors directed in the second directions.

38. The device of claim 35, further comprising a shade between the pyranometer and the multiple photosensors.

39. A device for measuring irradiance comprising:
a pyranometer directed along a central axis of a frusto-conical surface; and
multiple photosensors distributed about the frusto-conical surface.

40. The device of claim 39, further comprising an opaque shield that entirely overlies the multiple photosensors.

41. The device of claim 39, further comprising an opaque shield arranged to shadow the multiple sensors from direct sunlight traversing an arc containing the central axis.

42. The device of claim 41, wherein the arc is at least 45 degrees.

43. A system for monitoring an efficiency of a photovoltaic array comprising:
a module configured to determine an amount that an output of the photovoltaic array differs from a predicted output for the photovoltaic array; and
an irradiance sensor adjacent to the photovoltaic array, wherein the irradiance sensor comprises multiple light detectors directed in different directions and an opaque light shield that entirely overlies a portion of the multiple light detectors.
